(19) United States
(12) Patent Application Publication
(10) Pub. No.: US 2009/0310187 A1
(43) Pub. Date: Dec. 17, 2009

(54) Face Simulation in Networking

(76) Inventor: Scott C. Harris, Rancho Santa Fe, CA (US)

Correspondence Address: SCOTT C HARRIS, P O BOX 927649, SAN DIEGO, CA, 92192, US

(21) Appl. No.: 12/138,229

(22) Filed: Jun. 12, 2008

(51) Int. Cl. H04N 1/40; G06Q 10/00

(52) U.S. Cl. 358/448; 705/28

(57) ABSTRACT

A system allows you to do things on the internet in a way you might do them in the real world. This system allows modifying your look on the internet, but only by an amount that changes your look like you could change it in the real world, e.g, with makeup or plastic surgery. More extensive changes are not allowed, to prevent the user from masking their identity or characteristics via the editing of their looks.

### BACKGROUND

Different applications on the Internet involve interacting with other people on the Internet. Electronic games allow playing games, either against a simulated person or against other real people either locally or remote. Online gaming sites, such as world of warcraft and others, allow people to carry out different operations and have their own persona indicative of those operations.

The Internet also allows other actions to interact with others, including chatting in chat rooms, social networking, e-mail, and others. All of these applications represent “you” on the Internet by something on the internet. That something may be an avatar, or may be some other indicia indicative of “you” and “others”.

### SUMMARY

The present application describes special applications of avatars. Another application describes a special way of meeting on the Internet using this special avatar application.

### BRIEF DESCRIPTION OF THE DRAWINGS

These and other aspects will now be described in detail with reference to the accompanying drawings, wherein:

FIG. 1 shows a basic block diagram of a person interacting with a computer system.

FIG. 2 illustrates a flowchart of operation;

FIG. 3 shows a face modeling system; and

FIG. 4 shows a social networking system with huddles and storefronts.

### DETAILED DESCRIPTION

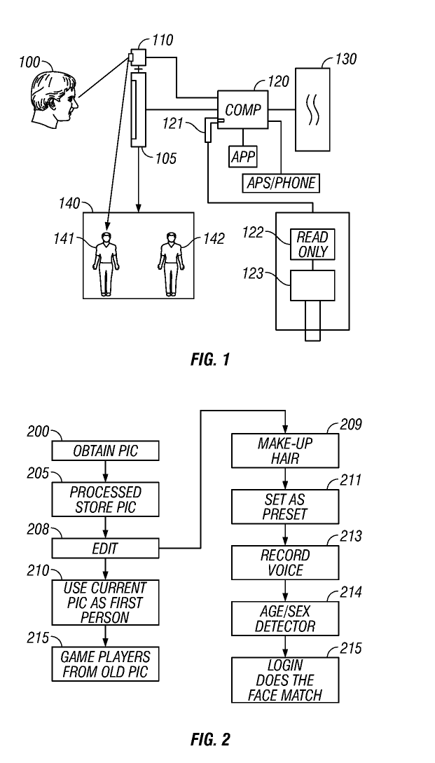

FIG. 1 shows a block diagram of a “user” interacting with a computer-based interactive system. The interactive system can be a personal computer running a program that interacts with the internet, or can be a dedicated video gaming console such as a Sony Playstation or Xbox, or any other type device that allows interaction via a user interface and display. The user typically sits in a location in front of the display screen 105.

In an embodiment, camera 110 may be located to obtain a picture or image of at least the face of the user 100. In one embodiment, this camera may be connected to a computer system. In another embodiment, this computer may be connected for example to a dedicated video game console such as a Sony PlayStation or the like. The computer interacts with an application program 121 to create a video screen. The computer may also connect to the Internet shown as 130, or more generally to any other network connection. The display screen 105 may display an interactive scene shown generally as 140. The picture and/or video obtained by the camera 110 is modified and displayed as part of the image displayed to at least one user viewing the image 141 on the display. The display may be interactive, and view information indicative of other users such as 142. The other user 142 may be a current user—e.g. someone in some other location at a current time. the other user may also be a previous player, someone who played at a previous time. For example, the camera 110 takes pictures of users who are playing a game in one embodiment. The camera can alternatively be built into the body of the console having only a lens exposed on the front surface. The camera takes pictures of persons who are participating in a website, in another embodiment. Those pictures are stored in the computer.

The computer may execute the flowchart of FIG. 2, which may be executed for example on a dedicated gaming console system such as an Xbox or the like. Such a gaming console inputs a game that has copy protection and/or play protection from a removable memory source 121, and plays the game directly from that source. For example, the source can be a prestamped DVD in an xbox, or a cartridge or other type device in certain Nintendo machines. Each of these devices checks to determine whether the game copy that is currently being played has been illegally copied. Only for example prestamped games with appropriate characteristics are allowed to play.

For the first time, this system allows a dedicated game console of this type to include a picture of the actual person as part of the game being played.

According to another embodiment, the removable memory source 121 is a nonvolatile read/write memory, either completely changeable, or partly read only and partly changeable. This may use, for example, the techniques described in my co-pending application Ser. No. 12/013434, filed Jan. 12, 2008, the disclosure of which is here with incorporated by reference.

In one embodiment, the removable memory source 121 may include a read only portion 122, as well as a read write portion 123. The read write portion may include the main executable of the game, or only a portion of the executable of the game. The read only portion may include cryptographic keys, such as a private key for the game. In one embodiment, the read only portion 122 may include a private key which is used to form a message using a real-time clock that is stored within a gaming console 120. The message is sent over the Internet 130, and verified by a server before the game is allowed to be played. In another embodiment, a cryptographic signature within the read only portion 122 may be verified by the console 120 without sending it to the remote location, or by sending it to the remote location only at certain intervals.

One advantage of this system is that the game is stored in read/write memory, and hence updates to the game can be downloaded from the Internet 130 as necessary. Moreover, even if they game portion 123 is hacked, the encryption techniques may effectively prevent the console from playing the game or from connecting on the network.

The removable memory source in these embodiments may be a USB-based memory, has shown, or alternatively may be in a smartcard style form factor for example.

At 200, the computer system obtains a picture of the person in the field of view of the camera. The picture is processed and stored as described in further detail herein.

The current picture is then used as the first person at 210. However, certain games and/or applications show other people in addition to (or in place of) the first person player. For example, in a baseball or football game, there may be many players forming each team. Some of those players may have their faces selected from stored pictures at 215. Presumably these people are friends or relatives of the person who owns the gaming console, since these are people who have played previously on the gaming console and have had their faces stored. This gaming console may modify people within the game to display those people using faces and information from the current person's circle of friends. This compares with the prior art where these games have used either prestored characters/faces, or generic avatars. Here, the games and/or other application(s) display stored faces of previous players.

More generally, however, this face may be placed into any interactive application: games, chat, social networking or any other kind of website.

Processing of the face is shown in 205. The face is added to a body to be used as part of the application. In embodiments, as described herein, the face is edited at 208 prior to being used as part of the application.

If a crisp picture of the face was used, I recognize that the face itself might not look natural or realistic in the online environment. People also often don't like the way they look at any given moment—they would prefer to adjust that look. However, on the other side of this issue; some applications, such as the social networking applications described herein, make it desirable that the person who is speaking looks somewhat like the actual person both for realism and also for certain security aspects.

According to a first embodiment, the editing at 208 modifies the face picture by cartoonizing or photorealimizing this face picture prior to its use. Cartoonizing may use, for example, conventional programs and plugins, such as those found in adobe photoshop, to make the image of the face look more like a cartoon. Cartoonizing may also use the techniques described in, for example, WO/2006/003625 or United States Publication 20070008322.

A special photo-processing technique is disclosed herein for modifying the obtained pictures at 208. This uses special techniques to force the image to look less like an actual photograph. It also allows editing of only certain aspects of the image, prior to display. However, only certain aspects can be edited, to make sure that the image being displays bears certain resemblances to the actual user. The inventor calls this technique a limited-photo-derealization system, since it makes the photo or frames of the video look more real; however it is “limited” in the amount of derealization of the photo that it can carry out. The overall goal is to change some parts of the picture, while making the picture remain recognizable as the person.

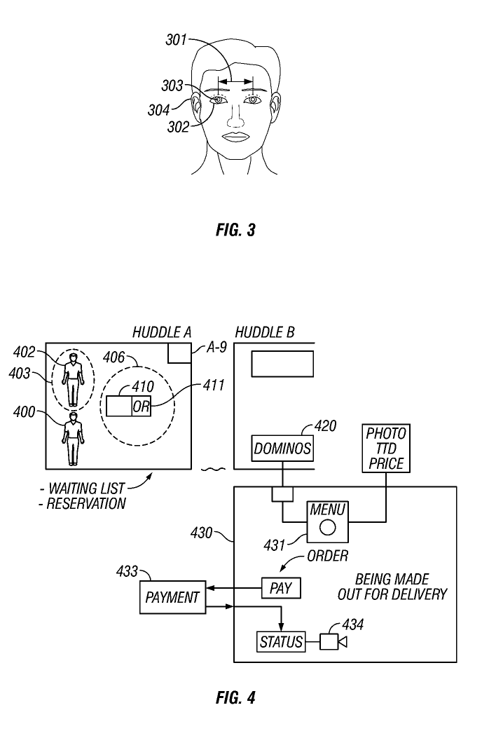

A special image derealization system as described herein models the face according to a number of different parameters. In this embodiment, the face is passed through a feature-quantizing filter. That filter determines characteristics of the face including those illustrated in FIG. 3. Each of the different face characterization parameters may be measured. Without limitation, this may include a distance 301 between the eyes. It may include the shape of the eyes 302; the color of the eyes 303; the shape of the ear shown as 304; the position of the ears; type of earlobe. It can include the distance between the eyes and mouth; the size, shape and orientation of the nose, neck location; chin size and chin location; hair color; hair line. In general, all of the sizes and shapes of the features of the face are obtained: including skin type, color and tone.

Each of these features are characterized, thereby forming a model of the face. The model, in essence, however, quantizes the face characteristics, since it changes the face characteristics in a way that makes it look like the face. When the model is used to recreate a face image, the level of detail can be reduced. This may remove many of the specific characteristics of the face. The model is then reconstituted to create a drawing of the face. The reconstituted face looks like the original face, however has less individual detail than the original face. Coarser quantization of the face shape and type make the face look more generic (more cartoonized) while still having an overall look like the original face. Hair color and hairstyle are also modeled.

The model and the modeling can be carried out relatively quickly. In addition, the camera 110 can continually monitor the face, thereby detecting changes in the face. This monitoring allows detecting changes in the facial expressions, for example when the person smiles, cheek movements, and the like. Head movements may also be monitored in a similar way. These movements can be used as part of the model to show similar movements on the modeled individual.

One embodiment may require a specified number of changes per unit time, to ensure that the person is really sitting in front of the camera. Otherwise, the system could be spoofed by putting a regular picture in front of the camera.

An advantage of this system is that the image that is displayed on the website looks like the person who is sitting in front of the camera. It is not necessarily the exact image of the person, but is necessarily based on the person's actual looks. This is good because people interact in a number of ways. People react to others based on their looks. By seeing the way someone's eyes look, the way someone's face looks, their smile, and the like, people change the way they react and speak. In one embodiment, since eyes and mouth may be an extremely important part of the communication process, actual images of the eyes and/or mouth may be used.

However, there have been instances where people have logged on as someone else on a website and impersonated that other person. In the process of impersonating them, they may carry out undesirable actions such as scams or cyber bullying. Any damage of this system is that it deanonymizes the Internet, by forcing users to use at least a portion of their own likeness on the Internet to represent them. The picture shown on the internet is not the exact likeness of the user who is in front of the camera, but has a close enough likeness to avoid someone masquerading as a completely different person.

The face modeling system also may allow certain kinds of edits. According to an embodiment, only some kinds of edits are permitted. Edits which would make too much change to the look of the user are disallowed. The edits may allow the user to change some parts of the way they look, in the same way that a user might apply makeup before going out for a date or going out with a friend. The user can virtually apply their makeup, change their hair, etc; but cannot actually make themselves look different than their actual look. According to this embodiment, the editing is not allowed to change anything that could not be changed by a user in the real world: e.g., makeup, clothing etc. Another embodiment may allow surreal makeup: allowing changing things that could be done by plastic surgery, e.g., reducing weight, implants of various types, and others. This allows people to improve their look, but requires that the people keep their essential look. This thereby prevents the wholesale anonymizing of the Internet. The editing which is allowed to be carried out at 208, for example, may include makeup, hair, spot removal or other type imperfection removal on the face, getting or covering tattoos, putting on jewelry, or piercings, or other decorations that can be done in the real world.

In the real world, a user can use makeup to change their skin tone or hair color. A number of colorings may be controlled using color palettes, and sophisticated systems such as any of the different controls available in Adobe Photoshop. A user can set their preferred settings for colors, hair, etc and save those settings as “presets” that can be used in other applications.

By limiting the amount of change, we prevent people from looking like things they aren't. For example, we do not want to let an old man look like a young boy or a young girl. We don't want a parent to be able to look like their child. Rather, this system only allows changes to certain features that improve the look of the user with those certain features. However, according to this embodiment, changes that change the overall look of the user are not allowed.

In certain games, the whole body of the user is shown. For example, in so-called first-person games, the user may have a body that is used to walk around in the virtual area defined by the game. A social interaction embodiment is disclosed herein, that allows movement in an analogous way. According to this embodiment, the body should match the face. Since the skin tone and neck size is determined as part of the modeling, that skin tone and neck size should translate into a body that is selected for the face. A database may be used to relate different face characteristics such as skin tone and head size to different sized people and body shape. This database may also use other user information, such as their height and weight. All of this can be used to make the body and actual face to look more natural.

In another embodiment, different tiers of users are allowed to make different levels of changes to their looks. For example, the basic tier of users may only be allowed to change their hair and clothes. Other tiers of people may be allowed to put on different kinds of makeup. Other tiers may be allowed to carry out plastic surgery style changes to themselves via the looks editor.

Another embodiment matches a user's voice at 213 to the body and/or face. A voice is recorded, and a voice model of that recorded voice is obtained. The voice model is used with the face and body whenever the user speaks within the application. By using a person's real voice associated with the body and/or face, the speaking will appear to be more natural for the body. The inventor recognizes that a voice sounds more natural coming from a person who it looks like.

Another embodiment shown as 214, uses an age or sex detector, and attempts to determine characteristics of the age or sex of the person. By determining characteristics of the age or sex of the person, this determination can be used as part of determining if the person is doing appropriate things on the Internet. For example, a 50-year-old man may be prevented from speaking to a 12-year-old boys, by an automatically-enforced computer based rule.

Another embodiment may be used with a login system to determine whether a currently-obtained face matches a face previously registered, before allowing the person to continue in the game. This may avoid a mother posing as a daughter for example or the like.

Other applications become possible from this system; in which a person's likeness can be simulated and edited, but the amount of editing is limited to prevent changing the look of the person, e.g., changing looks that effect their age, sex or other features that may be important in a site that allows interacting with others.

Another embodiment relates to use with a social networking website.

A social networking site has a goal of allowing interaction with friends. But how do you actually make friends? In many sites, there is no easy way to make new friends beyond those you have in the real world. For example, in Facebook.com, you cannot really make friends: You can only come into face book with friends you already have, and try to make new connections based on those connections to those connections you already have. While the connections to connections may provide interesting results, it does not really provide a way to make new friends

In myspace.com, you can make friends by asking someone if they're willing to be your friend. However, you have no way to find these people other than their profiles.

Part of this embodiment, like other embodiments herein, tries to carry out actions on a website, using computer input devices and computer hardware, that simulate the way things are done in real life. The inventor recognizes that one way of interacting with other people is by “hanging out”. You may make friends by meeting people in a store, meeting people in a bar, just going through life. Sometimes you may just want to stand around to make friends. However standing around with nothing to do in real life, may be somewhat awkward. Also, there may be certain stigma associated with the idea of someone who just stands around and doesn't really do anything. What if you just want to stand around and watch? What if at other times, you just want to talk to people who walk by? Similarly, at a party you may stand around, but you might feel awkward if you're standing around by yourself. Or what about if you don't know anyone at the party? However, on the Internet, things are a little different.

The present system describes a way of sending anonymizing yourself, but also removes many of the aspects of social awkwardness. When you're on the Internet standing by yourself, you may feel a lot less self-conscious than you would if you were actually in a place standing by yourself. The embodiment therefore uses the computer 120 connected to the Internet as a client, to contact a server which maintains a virtual system where a number of people, including yourself, can congregate. This embodiment calls this congregation a “huddle”. For example, FIG. 4 shows a huddle including “me”, shown as 400, but there are many other people within the huddle also shown as 402, and others. In fact, while only two actual people are shown, there are many other people within the huddle shown as 406, 408. Controls on the user interface for the computer allow a person to move around the huddle. The person 400 is you, but choose look like you although you may not look exactly like you and the person 400 looks somewhat like you. As you move around, you “see” others. Based on seeing these others, you can tell if perhaps you know them, because it looks like virtual representations of the other people. You can also talk to them, otherwise interact with them, and follow their facial expressions. For example, each person may define around them a “wingspan” shown as 403. By coming into the “wingspan” of a person, you enable communications with that person. However, unlike in the real world, you can stand in the huddle all by yourself without feeling self-conscious. You can talk to anyone in the huddle, and be semi-anonymous, or you can agree to exchange personal information. The communication within the huddle may be using the audio system described above, or may be by text chat, or the like.

The social networking site may have more than one huddle. FIG. 4 also shows how huddle A may include a different demographic of people then huddle B. Preferably the demographic of the huddles are different. The huddles may be arranged by age and/or sex, to avoid 12-year-olds being in the same huddle with 50-year-olds. Another embodiment may automatically determine the age as described above, and prevent a user from entering a huddle that you do not belong in.

In one embodiment, users on the website are allowed to enter one of a number of different huddles. You may select a huddle from among the huddles you are authorized to join. Alternatively, in another embodiment, the huddle may be selected for you randomly. In yet another embodiment, the website may automatically determine your location, for example by GPS or IP address, and use those GPS coordinates to set a huddle, so that people in the same geographic location are placed in the same huddle.

The GPS coordinates, for example, may also be automatically obtained from a telephone, e.g., a cell phone, that is on the person of the user; like a portable phone that is in communication with the computer 130.

An embodiment sets a maximum number of people that can be located in the huddle. When the huddle is full, the user can ask to go on a waiting list. In another embodiment, the user can make a reservation to enter a huddle at a specified time. In yet another embodiment, the huddle may expand in size as more people come into it, preventing the huddles from filling.

The interactions in the huddle may take any of a number of different forms. One form of interaction may be games or contests that are carried out in the huddle. Another form of interaction may grade the way that people interact within the huddle. However these interactions are carried out, the participation is scored. Participants with higher scores can do more things. For example, participants with higher scores may be able to obtain more abilities to modify their looks. They may attain priorities on the waiting list. They may attain better ability to move within the huddle. They may be able to obtain different looks, for example more brightness within the huddle.

In addition to contests, one desirable feature within the huddle is that everybody be willing to talk to everybody else. Accordingly, the pro-social behavior within the huddle may be scored. Low scores may be obtained for cliquish behavior, for example refusing to answer a question someone asks, or refusing to talk to someone. Reductions in scores may also be obtained for rudeness, for example banging into someone within the huddle without saying “excuse me”. Increases in score may be obtained for desirable actions such as speaking to strangers, or the like.

A number of people may decide to meet in a meeting place within the huddle. For example, people may send a huddle invitation saying “let's meet in the huddle A area A at 9 p.m”. The huddles may be divided into different areas that are different. People may want to reserve a spot to avoid a waiting list. You can send a meeting invitation which includes confirmation of the spot. The meeting invitation may be confirmed by the website by sending an code that allows entry into the huddle or adding a user's identification name to an “approved” list.

In one embodiment, different areas in the huddle have different features and different operations. For example, the huddle may have a center area shown as 410. That center area may include a bulletin board 411 that talks about different areas in the huddle and what is happening at those different areas either right now or at some time in the future. In one embodiment, simply entering the huddle without a specific invitation or may cause the user to arrive automatically near the bulletin. Another embodiment puts all new entries into the huddle at a random location, or at the location which is least populated. As described above, the invite code may be an area of the huddle into which the user wants to go.

The bulletin board 411 may include not only ongoing activities, but also requests. For example, any user may post a request such as “does anyone want to talk about sesame ice cream?”. The bulletin board may also say “activity x is going on in quadrant 89 in five minutes”. Different activities such as spelling bees, Sudoku, tests, and the like may be carried out.

The huddles can also include, however, commercial content. For example, huddles may have advertisers, and/or storefronts into which the user can be directed. For example, huddle B shows a Domino's advertisement shown as 420. A user can walk onto the advertisement to automatically be teleported to the storefronts. Say the user wants to buy a pizza from Domino's. The storefront can be used to provide, within the huddle, real time information about a transaction. For example, a pizza can be purchased using the on line virtual ordering system. In the huddle embodiment, the user enters into the huddle, and is transported into the storefront shown as 430. Within the storefront, the user is provided with a number of different possibilities. One of these possibilities is a menu shown as 431. The menu has a number of different items on it. Each of the items, for example, may be associated with different information about the item. By selecting the item, that information can be brought out such as a real photo of the item, a time to delivery, uprights, nutritional information. The user can order any of these items off the menu, and upon pushing up a button, go to a payment window shown as 433. After payment, the order is in process, and the user returns to the virtual restaurant storefront.

Application of this system is described herein, to form a real-time monitor over the order, from the moment is placed until the moment it is delivered. This makes it possible to order on the website, and from the moment of ordering, obtain real-time viewing of the order's progress. In essence, this provides a real-time view into the supply chain.

The user in the restaurant has the user's status associated with the order. The user can walk at any time, for example, to a real-time status and board that shows the real-time status of the order. The order has already been transmitted to a bricks and mortar version of the store, for example the real Domino's where the pizza is being made. Note that while this describes being used with the huddle system of FIG. 4, it can also certainly be used with other websites, simply allowing the order and real-time status part.

In the real Domino's, there may be a number of cameras, shown for example as 434. The real-time status window may say pizza is being made, and may show a camera version of the pizza being made using a web cam. At sometime after that, the order status changes to out for delivery. The out for delivery status may have a real-time estimate of time to delivery. There may also be a camera, for example, in the delivery person's car, which shows the real location of the delivery person. As an alternative, a GPS tracker in either the delivery persons car or in a delivery person's cell phone may show the delivery person's real-time location on a map. The status window may also show who's in front of me for delivery; estimated time to delivery, and the like.

While this has been shown for the embodiment of a pizza at places like Domino's, it should be understood that this can be used for many other purposes. It may be used to secure a place in line at a restaurant, getting real-time status of who's in front of you, and where the various people are in their eating (for example “11 tables have received their bills”) and the like. He can be used for ordering clothing or other merchandise. The real-time status can be obtained from different terminals, for example the delivery person cell phone. It can be used for common carrier or the common carrier person's cell phone and shows their real-time status. Moreover, the user can enter and leave the storefront at any time. The user can leave and come back and see the real-time status upon returning. For example, you could leave the Domino's and go to another storefront or go to a different huddle, but return to see the real-time status. By sitting at your home computer, you can see the real-time status of any order you've made by entering that storefront. For example, a UPS storefront may be entered, and the packages associated with the user automatically tracked on a bulletin board in the storefront. Moreover, the system can carry out real time tracking of those packages, e.g, showing the inside of the truck on which the item is located, or showing GPS results on a map as to exactly where the package is located.

The system can also be used for other purposes besides stores. For example, this can be used for doctor appointments or other kinds of appointments. The appointment can be made, and the user can see the waiting room, see their last visits, see test results and see doctor messages. Each item within the store within the area becomes part of what is in essence a huddle.

According to another embodiment, this can be used, for example, for airlines, e.g. airline reservations, itineraries, flight status, statistics, and flight check-in. Real-time versions of what is happening on the flight, the waiting room at the airport, and the lines at the airport can also be seen in an analogous way.

When a user enters this storefront, all of the above-discussed information is displayed at different locations within the storefront. The user's identity may be automatically ascertained, e.g., by determining a user name or other way. Based on the user's identity being detected in a store, all information associated with that identity can be displayed within that store, e.g., on simulated boards within the store. The boards can display text, maps showing real time location of the delivery person/etc, windows showing camera results, and/or all of the information discussed above.

An advertiser for software or games or the like can also advertise their product. By stepping on the banner, this may open a new window, that provides you information about the product. If it may open a trial software version of the product that can only be played within the huddle, thereby avoiding the problems of piracy or improper use of pirated software. If the trial version is a big download, for example, a user may be guided to or otherwise allowed to do other things in the background.

The general structure and techniques, and more specific embodiments which can be used to effect different ways of carrying out the more general goals are described herein.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, while the above describes certain kinds of operation over the internet, any other way of interacting via a shared network can be similarly controlled in this way.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be an Intel (e.g., Pentium or Core 2 duo) or AMD based computer, running Windows XP or Linux, or may be a Macintosh computer. The computer may also be a laptop.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A method comprising:
obtaining a picture of a user to be used as a part of an application carried out on the internet whereby other users on the internet see the picture;
allowing said picture to be modified only in ways that could be modified by a user modifying their own appearance in the real world; and
sending said picture to be used as part of said application.

2. A method as in claim 1, wherein said picture is allowed to be modified only to carry out a specified subset of operations on said picture.

3. A method as in claim 1, further comprising allowing storing presets indicative of multiple modifications to said picture.

4. A method as in claim 1, wherein said application allows determining a score associated with the user, wherein users having a more desirable score are allowed to carry out a second subset of operations which includes more operations on the picture than a first subset of operations; and wherein only said first subset of operations are allowed to be carried out by said users with a less desirable score than said more desirable score.

5. A method, comprising:
receiving an order of a product for delivery;
prior to a delivery of said product, determining real time information about an actual location of said product which has been ordered; and
displaying said real time information about said actual location of said product.

6. A method as in claim 5, further comprising determining an identity of a person who has ordered a product for delivery, and wherein said displaying comprises displaying responsive to an indication of said identity.

7. A method as in claim 5, wherein said real time information is a real time location information of the product to be delivered based on automatic position detection.

8. A method as in claim 7, wherein said real-time location comprises a display on a map the real time location of the product.

9. A method as in claim 5, wherein said real time information is live image information from a camera.

10. A method as in claim 5, wherein said product is delivered food.

11. A method as in claim 5, wherein said product is merchandise that has been ordered from a seller, and said real time information includes a status including a specific geographical location of the order.

12. A method, comprising:
ordering, on the internet, a product to be delivered; and
after said ordering, and during a time that said product is being moved from one location to another location, viewing on the internet, real time information about an actual location of said product which has been ordered.

13. A method as in claim 12, further comprising determining an identity of a person who has ordered a product for delivery, and wherein said displaying comprises displaying responsive to an indication of said identity.

14. A method as in claim 12, wherein said real time information is a real time location information of the product based on automatic position detection.

15. A method as in claim 14, wherein said real-time location information is a GPS detection and said display shows a display on a map of the real time location of the product.

16. A method as in claim 15, wherein said real time information is live image information from a camera.

17. A method as in claim 5, wherein said product is delivered food.

18. A method as in claim 5, wherein said product is merchandise that has been ordered from a seller, and said real time information includes a status including a specific geographical location of the order.
